(19) United States
(12) Patent Application Publication
(10) Pub. No.: US 2008/0259909 A1
(43) Pub. Date: Oct. 23, 2008

(54) Signaling of Early Media Capabilities in IMS Terminals

(76) Inventors: Stefan Runeson, Lund (SE); Sven Christian Georg Andersson, Lund (SE); Peter Hedman, Helsingborg (SE); Johan Sorensen, Eslov (SE)

Correspondence Address: COATS & BENNETT, PLLC, 1400 Crescent Green, Suite 300, Cary, NC, 27518, US

(21) Appl. No.: 12/046,878

(22) Filed: Mar. 12, 2008

Related U.S. Application Data
(60) Provisional application No. 60/912,360, filed on Apr. 17, 2007.

(51) Int. Cl. H04L 12/66

(52) U.S. Cl. 370/352

(57) ABSTRACT

Methods and apparatus are disclosed for processing Session Initiation Protocol (SIP) INVITE messages that include an early media capability indicator. The early media capability indicator provides information regarding the early media handling capabilities of the device originating the message, and is used by various network nodes that process the INVITE message to determine if, and under what circumstances, early media sessions may be established with the originating communication device. In an exemplary method, a SIP INVITE message is received from a SIP User Agent Client for a first communication device, the SIP INVITE message comprising an early media capability indicator. The exemplary method further comprises forwarding the SIP INVITE message to one or more remote communication devices, and selectively allowing one or more media sessions between the first communication device and the one or more remote communication devices, based on the early media capability indicator.

### RELATED APPLICATIONS

This application claims priority under 35 U.S.C. § 119(e) from the U.S. Provisional Patent Application Ser. No. 60/912,360, which was filed on 14 Apr. 2007 and entitled “Early Media Capabilities in IMS Terminals.”

### TECHNICAL FIELD

The present invention relates generally to signaling in a data communications network, and more particularly relates to methods and apparatus for processing SIP-based multi-media service requests.

### BACKGROUND

The IP multimedia subsystem (IMS) was developed by the 3rd-Generation Partnership Project (3GPP) to provide a common standardized architecture and standardized interfaces for providing IP services in a mobile networking environment. The IMS network is independent of the radio access technology used by devices accessing the network, and will interoperate with virtually any cellular network. IMS uses the Session Initiation Protocol (SIP) as the service control protocol, which allows operators to offer multiple applications simultaneously. The IMS standard is expected to speed the adoption of Internet Protocol (IP) services on mobile terminals, allowing users to communicate via voice, video, or text using a single client on the mobile terminals.

Early media is audio or video data that is exchanged between a called device and a calling device during call setup, before the call is established. It is often used today for ringing tones and announcements. In the case of SIP-controlled communication sessions, early media is defined as all media exchanged in a session from the time the SIP User Agent Client (UAC) sends an INVITE message until the time any User Agent Server (UAS) generates a final response, and the primary media session is established. (See RFC 3960, “Early Media and Ringing Tone Generation in the Session Initiation Protocol,” Internet Engineering Task Force, December 2004, for a more complete description of early media.)

An early media session may be established between two communication devices using an offer/answer exchange for negotiating the early media session parameters. This offer/answer model is the same model used to establish the primary media session. In some instances, the early media session may be established separately from the primary media session, using a separate offer/answer exchange. In these instances, the early media session terminates when a final response for the INVITE message is sent. In other instances, the early media session transitions to the primary media session when the final response is sent and received.

Because a called party may be associated with more than one communication device, SIP specifications include provisions for “forking.” SIP forking means that a SIP proxy or SIP application server can send an incoming INVITE message further to multiple SIP User Agents. This forking may be sequential, e.g., following a “forward-if-no-reply” model, or parallel, e.g., following a “reach-me-everywhere” model. In a forking situation, each User Agent Server that receives the INVITE message may attempt to establish an early media session with the UAC and begin exchanging early media. In such a situation, the UAC may concurrently receive two or more parallel early media streams.

Currently, there is no standard approach to how such concurrent early media streams should be handled by the UAC. In many cases, only one media stream can be rendered by a communication device at a time. In this case, all other media streams must be discarded by the UAC. Parallel early media streams may present additional problems for mobile terminals, because of the limited radio resources available. For example, 3GPP specifications currently require that only one media session be established at a time. If two or more parallel media streams are targeted to the wireless client, media packets may be randomly discarded, since the incoming data may exceed the data bandwidth available over the allocated radio resources.

Furthermore, media streams may include various audio and/or video data streams. Some SIP devices may have limited processing power for handling parallel media streams. In some cases, especially with wireless devices, the available bandwidth may be limited and/or expensive, compared to that available with wired broadband access. Thus, a potential problem with existing approaches to early media sessions is that scarce device and/or radio resources may be used for media streams that may ultimately be discarded by the receiving device.

### SUMMARY

Methods and apparatus are disclosed for processing multi-media service requests. In particular, methods for extending a Session Initiation Protocol (SIP) INVITE message with an early media capability indicator are disclosed. The early media capability indicator provides information regarding the early media handling capabilities of the device originating the INVITE message, and is used by various network nodes that process the INVITE message to determine if, and under what circumstances, early media sessions may be established with the User Agent Client for the originating communication device.

In an exemplary method, a SIP INVITE message is received from a SIP User Agent Client for a first communication device, the SIP INVITE message comprising an early media capability indicator. In some embodiments, the early media capability indicator may comprise one or more feature tags in the SIP INVITE message; in others, the early media capability indicator may be included in a Private Header extension to the SIP INVITE message. The exemplary method further comprises forwarding the SIP INVITE message to one or more remote communication devices, and selectively allowing one or more media sessions between the first communication device and the one or more remote communication devices, based on the early media capability indicator.

In some embodiments, the contents of the early media capability indicator may be used by a SIP proxy server or SIP application server to determine whether to utilize sequential or parallel forking. In other embodiments, the contents of the early media capability indicator may be used by a receiving end-user device or SIP application server to determine whether to initiate an early media session with the originating communication device. Various methods and apparatus for implementing these techniques are disclosed.

### BRIEF DESCRIPTION OF THE DRAWINGS

FIG. 1 illustrates a communication network 10 according to one exemplary embodiment of the invention.

FIG. 2 illustrates the architecture of a SIP client.

FIG. 3 is a ladder diagram illustrating session establishment between two end-user devices.

FIG. 4 is a schematic diagram illustrating SIP forking.

FIG. 5 is a logic flow diagram illustrating an exemplary method for processing multi-media service requests.

FIG. 6 is another logic flow diagram illustrating an exemplary method for processing multi-media service requests.

FIG. 7 is a logic flow diagram illustrating an exemplary sequential forking process.

FIG. 8 is a logic flow diagram illustrating another exemplary method for processing multi-media service requests.

FIG. 9 is a block diagram illustrating an exemplary server configured to process multi-media service requests.

FIG. 10 is a block diagram illustrating an exemplary end-user device configured to process multi-media service requests.

### DETAILED DESCRIPTION

While the invention is susceptible to various modifications and alternative forms, specific embodiments are shown by way of example in the drawings and will be described in detail below. It should be understood, however, that there is no intent to limit the invention to the particular forms described in detail. Those skilled in the art will recognize various alternatives to the illustrated embodiments that fall within the scope of the claims.

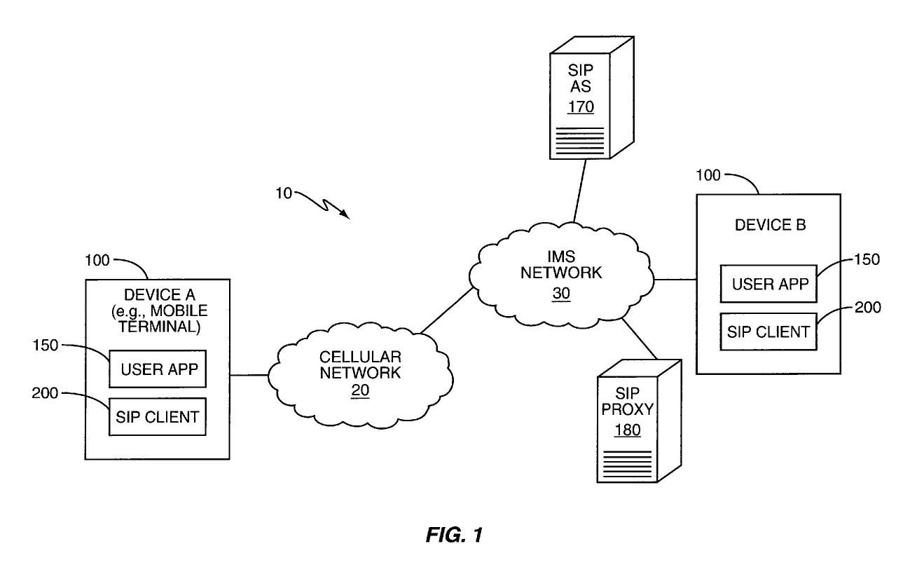

FIG. 1 illustrates a communication network 10 according to one exemplary embodiment of the invention. The mobile communication network 10 comprises a conventional cellular network 20 providing voice and/or data services, and an interconnected IP network 30 providing IP services. The cellular network 20, for example, may comprise a GSM, GPRS, EDGE, cdmaOne, cdma2000, WCDMS, UMTS, E-UTRAN/EPS (Evolved Packet Services) network, although other access technologies can also be used. The IP network 30 may, for example, comprise an IP Multimedia Subsystem (IMS) network. The IMS network 30 uses the Session Initiation Protocol (SIP) as a signaling protocol for communication between end devices. SIP is a text-based signaling protocol used for setting-up, modifying, and tearing down media sessions. SIP has also been extended for instant messaging and presence services. A gateway (not shown) connects the cellular network 20 and the IMS network 30. Two networked communication devices (NCDs) 100 are shown—a mobile terminal connected to the cellular network 20 and a computer connected to the IMS network 30. Each NCD 100 includes a SIP client 200 that interfaces with a user application 150. SIP client 200 functions as a SIP user agent to establish modify and terminate communication sessions between two or more end devices.

FIG. 1 also illustrates a SIP proxy server 160 and a SIP application server (AS) 170. As is well known to those skilled in the art, proxy servers typically play a central role in a SIP network, gluing together other SIP components, including end user terminals, gateways, application servers, and other domains. SIP proxy server 160 may thus provide security services, e.g., enforcing who may call whom, routing services, e.g., finding the correct recipient for a call, or a variety of other services, e.g., notifying users of missed calls, forwarding calls, call screening, and so on. SIP application servers may also provide some or all of these services. In some cases a SIP application server 170 may be co-located with SIP proxy server 160.

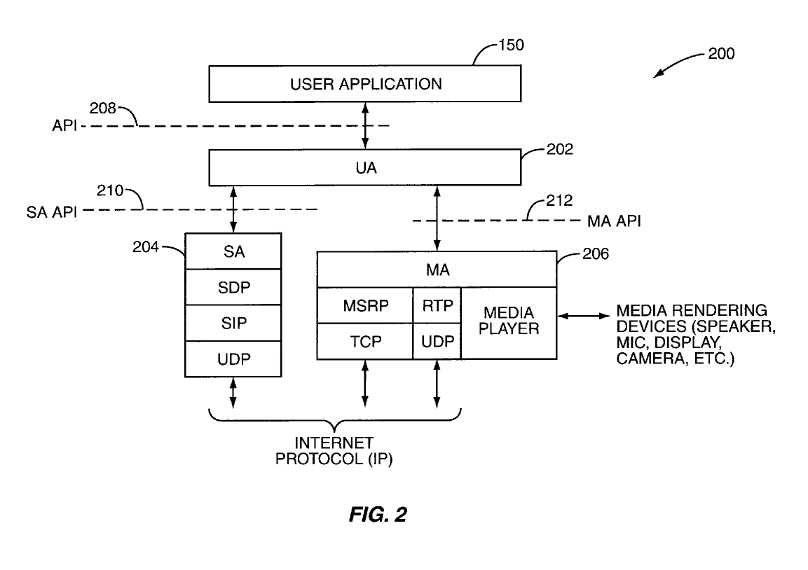

FIG. 2 illustrates the architecture of an exemplary SIP client 200. The SIP client 200 enables an NCD 100 to communicate with other NCDs 100 over a communication network. SIP client 200 provides a high-level application interface that insulates user applications 150 from the details of the underlying network protocols. Media connections appear to the user applications 150 as simple data streams, a/k/a pipes, which can be manipulated with simple open, close, read, and write commands.

SIP client 200 comprises three main components—a user agent (UA) 202, a signaling agent (SA) 204, and a media agent (MA 206) 206. UA 202 communicates with user application 150 and translates application commands into appropriate signaling and media operations. SA 204 and MA 206 operate under the control and direction of UA 202. The UA 202 has overall control over connection management, and delegates signaling and media management tasks to the SA 204 and MA 206, respectively. In the illustrated embodiment, SA 204 implements SIP and SDP protocols to handle signaling tasks. The SA 204 uses UDP over IP for transport of messages, but other session control protocols, such as H.323, could also be used. The signaling tasks include the set up, modification, and tear down of communication sessions, session parameters negotiations, remote device interrogations to determine capabilities, and presence detection. The MA 206 implements the Message Sessions Relay Protocol (MSRP) and the Real-Time Transport Protocol (RTP), and includes one or more media players to process and output media to media rendering devices. MA 206 manages media connections, routes media according to media type and user settings, and invokes media players to process media as required. The MA 206 uses TCP and/or UDP over IP for transport of RTP and MSRP messages.

In some realizations, a monolithic approach may be taken, which integrates the UA 202, SA 204, and MA 206 together in a single application. In other embodiments, these functional elements may be separated by inserting network interfaces at one or more of the Applications Programming Interfaces (APIs) 208, 210, and 212 shown in FIG. 2. This enable implementations where the UA 202, SA 204, and MA 206 may be separate applications distributed within the communication network 10. For example, interfaces 208, 210, and 212 may use a TCP socket connection or other type of network interface allowing the UA 202, SA 204, and/or MA 206 to be remotely located from the user application 150. In some circumstances, the distributed approach has several advantages over the monolithic approach. For example, the SIP client 200 may be located in a network server in the IMS 30 or other IP network and remotely accessed by an NCD 100 using, for example, telnet to open a socket connection. Thus, IP services can be provided to an NCD 100, such as a mobile terminal in a cellular network that does not have inherent SIP capabilities.

The SIP client 200 is implemented as a process running on a host device, such as a PC or mobile terminal. The host device includes memory in which to store code for implementing the present invention, one or more microprocessors to execute the code, and a communications interface to provide network access. (As noted above, UA 202, SA 204, and MA 206 may reside in different host devices.)

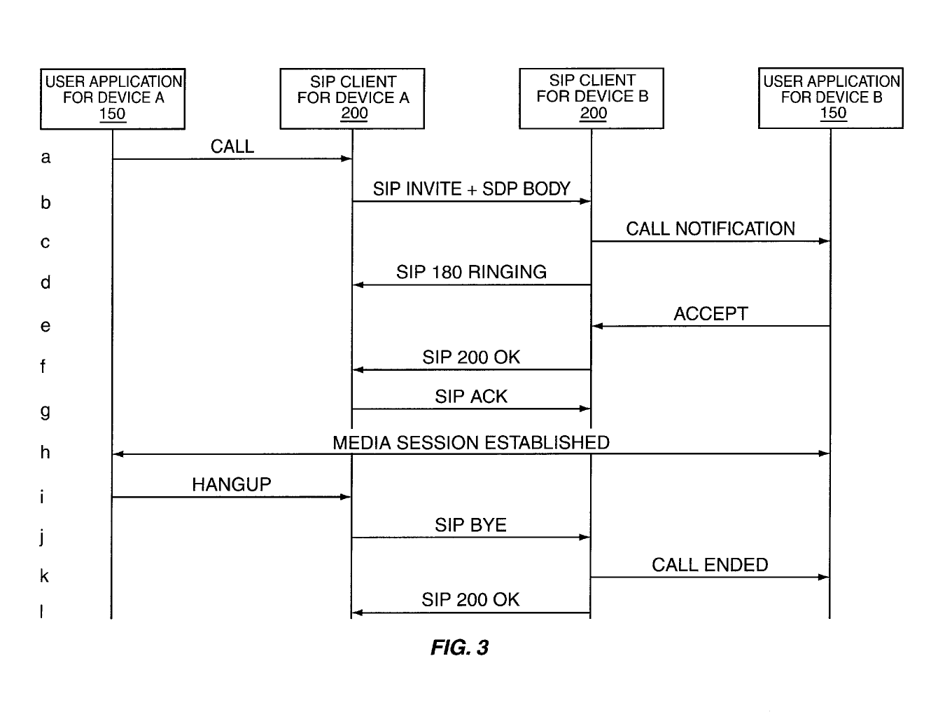

FIG. 3 shows a simple SIP exchange between two SIP-enabled NCDs 100. The two SIP-enabled NCDs 100 may be mobile telephones, computers, personal digital assistants (PDAs), or any other type of communication device connected to a network and having access to the IMS network 30 or other packet data network, such as the Internet. This example assumes that the devices know each other's IP addresses. The user application 150 in the calling device, Device A in this example, sends a CALL request to the SIP client 200 in Device A (step a). The SIP client 200 initiates call set-up by sending a SIP INVITE request to the SIP client 200 in the called party, Device B (step b). The INVITE request typically includes a SDP message body that describes the type of call that is being requested and gives the session parameters. For example, the requested session could be a simple audio session, a multimedia session, a videoconference, or a gaming session. The SIP client 200 notifies the called party (step c) and sends a 180 RINGING response to the SIP client 200 in Device A to indicate that the called party has received the request and that the called party is being alerted (step d). The 180 RINGING response is known as a provisional response. When the called party accepts the call (step e), a 200 OK response is sent from Device A's SIP client 200 to Device B's SIP client 200 (step f). This response includes an SDP message body indicating the requested session parameters have been accepted. The SIP client 200 for the calling party acknowledges the SIP 200 OK response by sending a SIP ACK message (step g). The SIP ACK may contain an SDP message body if the initial INVITE did not include an SDP message body. This exchange of messages allows an RTP or MSRP session to be established (step h). When the call is complete, the user application 150 for one party sends a HANGUP request to the SIP client 200 (step i). The SIP client 200 terminates the session using the BYE method, where the SIP client 200 sends a BYE request to the other party (step j). The SIP client 200 indicates to the user application 150 that the call is ended (step k) and sends a SIP 200 OK response to confirm receipt of the BYE request and to terminate the session (step l).

Those skilled in the art will appreciate that the signaling illustrated in FIG. 3 represents an extremely simple example of media session establishment. In many instances, one or more intermediate nodes, such as a SIP proxy or a SIP application server, may participate in the signaling. Furthermore, the signaling may be complicated by the need for resource reservation (e.g., of radio resources) at one or more endpoints. This may require the use of preconditions, as described in RFC 3312, “Integration of Resource Management and Session Initiation Protocol (SIP),” Internet Engineering Task Force (IETF), October 2002. These complications are reflected in the various signaling flows for session establishment illustrated in 3GPP TR 24.930, “Signalling flows for the session setup in the IP Multimedia core network Subsystem (IMS) based on Session Initiation Protocol (SIP) and Session Description Protocol (SDP)”, v7.3.0 (December, 2007).

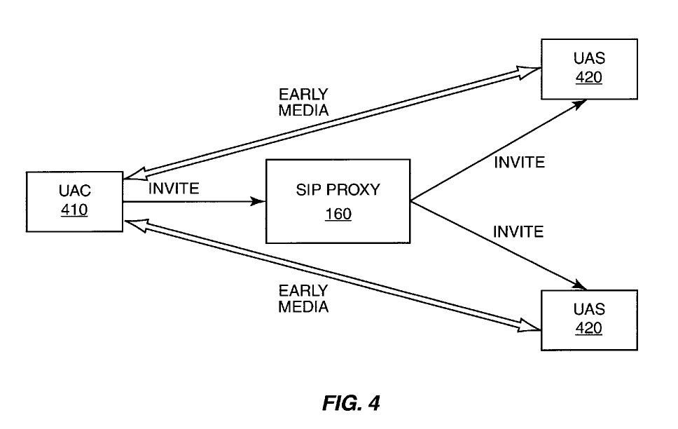

As noted above, particular problems with the handling of early media sessions may arise when requests for establishing a media session (e.g., an “INVITE” message) are processed by a SIP proxy server or application server that forks the request. As shown in FIG. 4, a SIP Proxy 160 may forward an INVITE message received from User Agent Client (UAC) 410 (which corresponds to a NDC 100) to two (or more) User Agent Servers (UAS) 420 (which correspond to other NDCs 100). As noted above, this forking may be sequential, where the INVITE message is not forwarded to the second UAS 420 until and unless the offer in the INVITE is refused by the first UAS 420. Alternatively, SIP proxy 160 may forward the INVITE to both UAS's 420 in parallel, in which case parallel early media sessions may be established between the UAC 410 and the UAS's 420. As was discussed above, UAC 410 may not be able to process two or more parallel early media streams and may thus be forced to discard all but one. In some cases, particularly when reservation of radio resources by UAC 410 is required, the allocated radio resources may be unable to support the parallel early media sessions. In this case, all of the early media streams might fail to be received and processed properly.

If a UAC 410 is provided with the capacity to express its capabilities for handling early media, then the possibility that scarce radio or network resources are wasted for media streams that will be discarded can be reduced. An early media capability indicator, included in an INVITE message by an originating UAC, may be used to signal those capabilities to network nodes that process the INVITE message, include SIP proxy 160, SIP application server 170, and SIP User Agent Servers 420. Each of these network nodes may use the early media capability indicator to determine if, or under what circumstances, early media sessions may be established.

As will be discussed further below, the early media capability indicator may be associated with or included in the INVITE message in several different ways. In some embodiments, the early media capability indicator may be included in header extensions, or in feature tags. Some of these approaches may require extensions to existing standards for the Session Initiation Protocol; others may utilize existing standards to carry this new information field.

The capabilities that may be signaled using the early media capability indicator are varied, but may include, for example, an indication that no early media is allowed, an indication that early media is permitted in a single dialog, an indication that two or more sequential early dialogs are permitted, and an indication that parallel early media sessions, in multiple dialogs, are permitted. Those skilled in the art will appreciate that these indicators may be extended to cover other SIP network configurations or signaling scenarios.

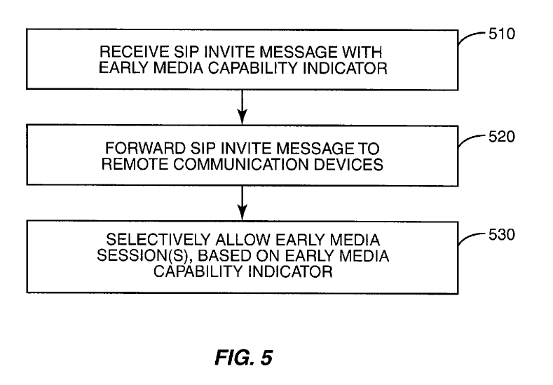

FIG. 5 illustrates an exemplary method for processing a multi-media service request that includes an early media capability indicator, such as might be performed at a SIP proxy or SIP application server. At block 510, a SIP INVITE message is received from a SIP User Agent Client for a first communication device. The SIP INVITE message includes an early media capability indicator as discussed above.

In some embodiments, the early media capability indicator may be included in a Private Header (P-Header) extension to the SIP INVITE message. For example, a P-Header extension called the P-Early-Media header field has been defined to allow proxies to authorize or de-authorize requests for early media based on a network-specific policy. (See RFC 5009, “Private Header (P-Header) Extension to the Session Initiation Protocol (SIP) for Authorization of Early Media,” Internet Engineering Task Force, September 2007.) The P-Early-Media header may be extended to include the early media capability indicator, e.g., by adding a parameter that may be set to one of several values indicating the capacity of the originating communication device to handle early media sessions. Such a parameter might be set, for example, to values indicating that no early media may be sent, that early media may be accepted in a single dialog, that multiple dialogs of early media may be handled, but in sequential, non-overlapping dialogs, or that two or more early media sessions may be established in parallel. In another embodiment, the early media capabilities of the originating communication device might be signaled using feature tags. Feature tags for SIP applications are defined in RFC 3840, “Indicating User Agent Capabilities in the Session Initiation Protocol,” Internet Engineering Task Force, August 2004.

Those skilled in the art will appreciate that the early media capability indicator may be signaled in a variety of other ways. For example, an early media capability indicator might be signaled as part of the Session Descriptor Protocol (SDP) instead of (or in addition to) SIP. An early media capability indicator in SDP could be per session, or even per media, and might be indicated by a media attribute line, as described by RFC 2327, “SDP: Session Description Protocol”, Internet Engineering Task Force, April 1998.

At block 520, the received SIP INVITE message is forwarded to one or more communication devices. In some instances, the SIP INVITE message might be forwarded to two or more remote devices, using so-called forking techniques. In some embodiments, as will be described in more detail below, a particular forking technique may be chosen based on the contents of the early media capability indicator. In some cases, parallel forking may be used, so that the SIP INVITE message is sent to two or more remote devices at substantially the same time. In other cases, sequential forking is used, so that the SIP INVITE message is sent to only one remote device at a time. In the case of sequential forking, the SIP proxy or application server may refrain from forwarding the SIP INVITE message to a second device until a final response is received from the first device.

At block 530, one or more early media sessions are selectively allowed based on the early media capability indicator. In the event that the early media capability indicator indicates that no early media should be permitted, the SIP proxy or application may reject one or more early media offers received from a remote device in response to the SIP INVITE message. (Preferably, User Agent Servers should be configured to process the early media capability indicator, and to refrain from initiating an early media session if early media is not permitted. However, a SIP proxy or application may nonetheless need to enforce the restriction by rejecting offers from non-compliant User Agent Servers.) Similarly, the SIP proxy or application may process other early media offers in accordance with the early media capability indicator. In some instances, this may comprise accepting a first early media offer, and rejecting subsequent offers, if the early media capability indicator indicates that one early media session is allowed. In other cases, this may comprise permitting sequential early media sessions, if the early media capability indicator indicates that multiple early media sessions are permitted, provided they are sequential. In yet other instances, the SIP proxy or application server may permit multiple, parallel early media sessions.

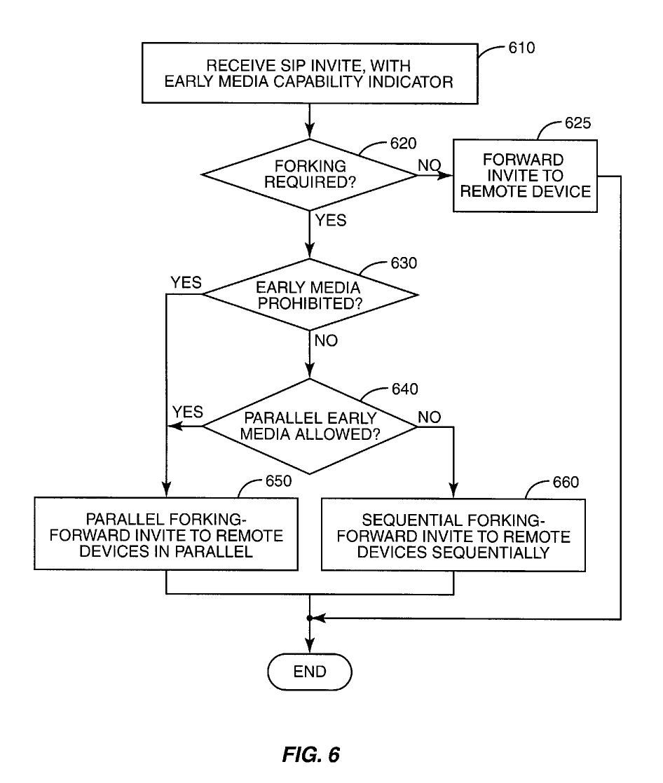

As noted above, in some embodiments a SIP proxy or application server may determine whether to use parallel or sequential forking at least partly based on the contents of the early media capability indicator. An exemplary method that might be implemented at such a SIP proxy or application server is illustrated in FIG. 6.

The process begins, at block 610, with the receipt of a SIP INVITE message from a first communication device, the SIP INVITE message including an early media capability indicator. At block 620, the SIP proxy or application server first determines whether any forking is required at all. This may depend, for example, on whether the user of the first communication device has configured a “follow-me” service, or a “try-me-at-multiple-locations” service, or the like. If no forking is required, then the SIP proxy or application may simply forward the SIP INVITE to a single remote device, and process subsequent messages as usual, as shown at block 625. Those skilled in the art will appreciate that this may include enforcing a “no early media” requirement, if the remote device ignores such a requirement indicated by the early media capability indicator.

If forking is required, on the other hand, then subsequent processing, in some embodiments of the invention, may depend on the contents of the early media capability indicator. At block 630, the SIP proxy or application server determines whether early media is allowed at all, by examining the early media capability indicator. If not, then parallel forking may be used (as appropriate), as indicated at block 650. Since no early media sessions are allowed, subsequent processing by the SIP proxy or application may entail enforcing this no early media policy. (The example illustrated in FIG. 6 assumes that there is no reason for using sequential forking other than for enforcing the early media restrictions indicated in the early media capability indicator. Those skilled in the art will appreciate that there may be other reasons to use sequential forking, in which case the logic flow of FIG. 6 may be modified accordingly.)

Similarly, if the early media capability indicator indicates that parallel early media sessions are allowed, as determined at block 640, then parallel forking may be used, again as shown at block 650. In this case, there may be no need for the SIP proxy or application server to be concerned with further enforcement of the early media capability indicator, unless the early media capability indicator provides some limit to the number of early media sessions that are allowed.

On the other hand, if parallel early media sessions are not allowed, then sequential forking, as shown at block 660, may be used. In this case, the SIP INVITE may be sent to several remote devices, but sequentially. This procedure aids, for example, in enforcing an early media capability indicator that permits multiple early media sessions, but only one at a time, or in enforcing an early media capability indicator that allows only one early media session.

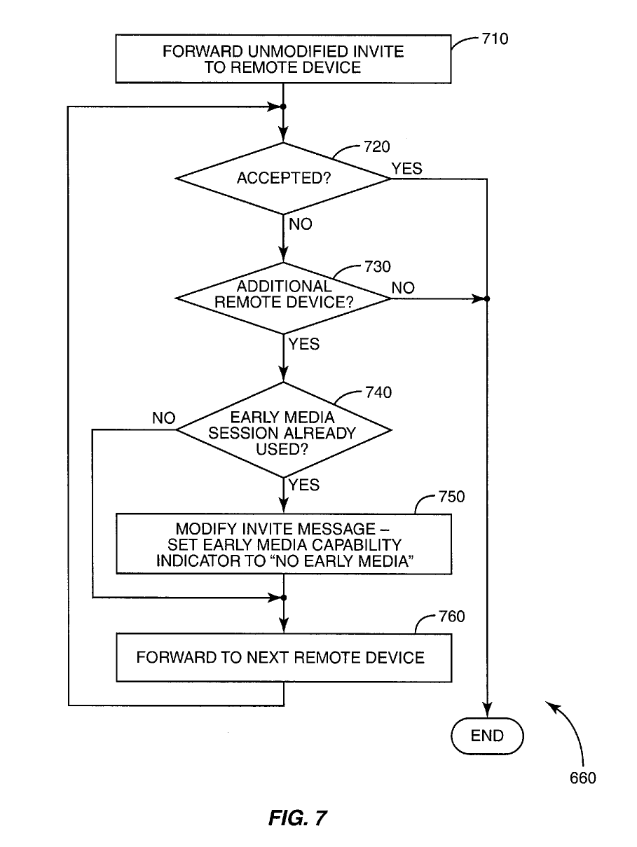

One approach to the sequential forking processing of block 660 is shown in FIG. 7. This approach might be used, for example, in a scenario where the early media capability indicator included in a SIP INVITE message indicates that only a single early media session is permitted.

At block 710, the SIP INVITE message is forwarded to a first remote device. Subsequent signaling is processed as normal, until it is determined, at block 720, whether the INVITE has been finally accepted or not. If it has, then no further forwarding is necessary, and the process ends.

If the SIP INVITE is refused, on the other hand, then the SIP proxy or application server may determine whether one or more additional remote devices remains to be contacted, as shown at block 730. If not, the process ends. If one or more remote devices remain to be invited, then the SIP proxy or application server's next steps depend on whether the first remote device already established an early media session with the first communication device. If not, then the SIP INVITE message is forwarded to the next remote device, as shown at block 760. On the other hand, if a remote communication device has already established an early media session with the first communication device, then the INVITE message is modified before it is sent to the next remote device, as shown at block 750. The steps of blocks 720-760 are repeated until all remote communication devices have been contacted or until a remote communication device accepts the invitation.

The modification of the INVITE message at block 750 may comprise changing the early media capability indicator, to regulate future early media sessions. Thus, if the original early media capability indicator indicated that only a single early media session was allowed, and if that single early media session was previously established, then the early media capability indicator in the INVITE message may be modified to indicate that no early media sessions are permitted. With such a modification, User Agent Servers for remote communication devices that are subsequently contacted should refrain from initiating an early media session. As was discussed above, however, the SIP proxy or application server may still need to enforce the restriction, by rejecting subsequent early media offers, in the event, for example, that one or more of the remote communication devices is incapable of processing the early media capability indicator.

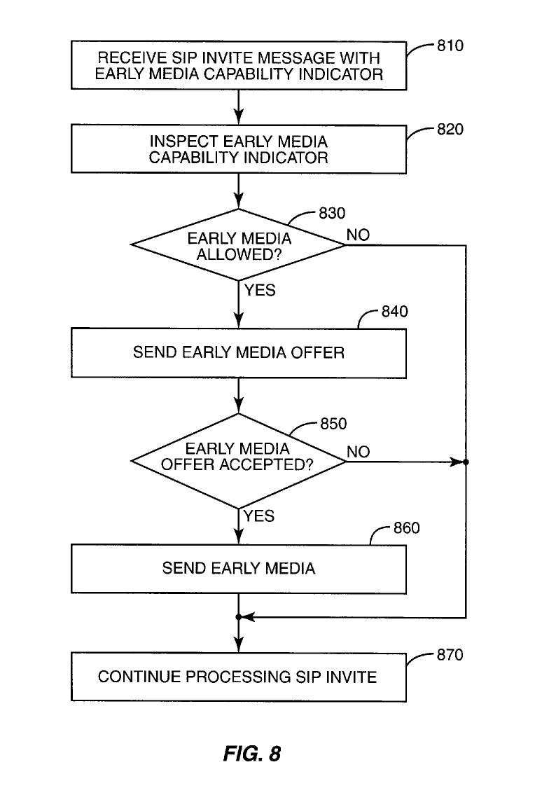

Preferably, however, communication devices are configured to inspect early media capability indicators in received SIP INVITE messages, and to act accordingly. A method for processing multi-media service requests that might be implemented by a User Agent Server for such a communication device is illustrated in FIG. 8.

At block 810, a SIP INVITE message, including an early media capability indicator, is received. This SIP INVITE message may be received by a User Agent Server for an end-user communication device, in some embodiments. In other embodiments, the SIP INVITE message may be received and processed by a SIP application server according to the illustrated method. In either case, as will be readily understood by those skilled in the art, the SIP INVITE message may be received from a SIP proxy forwarding the INVITE message on behalf of an end-user device, and/or the INVITE message may have passed through one or more other intermediate nodes.

At block 820, the early media capability indicator is inspected to determine what restrictions, if any, apply. If early media is allowed, as determined at block 830, then an early media session may be established. In this case, an early media offer is sent, at block 840, using conventional SIP signaling procedures. If the early media offer is rejected, as determined at block 850, then processing of the SIP INVITE continues as normal, as indicated at block 870 If the early media offer is accepted, on the other hand, then an early media session is established with the communication device that initiated the INVITE message, as shown at block 860. Those skilled in the art will appreciate that the early media session may in some embodiments be established directly with the initiating communication device, even if the INVITE message and/or the early media negotiation was conducted through a SIP proxy.

Once the early media negotiation is completed, processing of the SIP INVITE continues as normal. As is well known to those skilled in the art, this processing might conclude with an acceptance of the INVITE, in which case the early media session may either be terminated or continued as the primary media session. Alternatively, this processing might conclude with a rejection of the INVITE, in which case the early media session is terminated, again according to normal procedures.

Those skilled in the art will appreciate that the inventive techniques described herein are not limited to the specific embodiments, nor are the exemplary processing rules described herein necessarily applicable or binding to every SIP signaling scenario. Indeed, those skilled in the art will appreciate that the use of an early media capability indicator as described herein may provide network nodes with more information, and thus more flexibility, regarding the most efficient use of network resources. For example, a back-to-back User Agent (B2BUA) may receive an incoming INVITE with an early media capability indicator indicating that only a single early media stream can be supported by the originating UAC. In some situations, it may be advantageous to have the B2BUA remove the restriction from its outgoing INVITE messages, and select one of several early media streams established with remote devices for forwarding to the originating UAC. Those skilled in the art will recognize the applicability of similar techniques to various other network configurations and signaling scenarios.

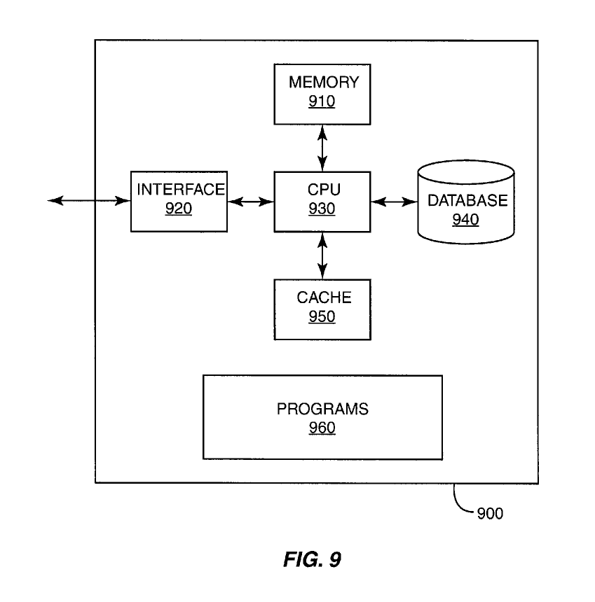

Those skilled in the art will also appreciate that any of the methods described above or illustrated in the attached drawings may be implemented at a server, such as a SIP proxy server or a SIP application server, providing one or more communication services for one or more end-user communication devices. FIG. 9 thus illustrates an exemplary server 900 according to one or more embodiments of the present invention. Server 900 comprises at least one CPU 930 connected to at least one memory device 910, a cache memory 950, at least one database 940 and at least one network interface 920. Memory devices 910 and databases 940 may include non-volatile memory, such as flash, magnetic, or optical storage devices. Network interface 920 enables the CPU 930 to send and receive data to/from the IMS network 30. The cache memory 950 allows storage of frequently used data so that the CPU 930 may obtain it readily. The database 940 may contain stored data associated with one or more communication devices, such as information indicating what services are available for one or more communication devices, or state information maintained for the one or more communication devices. The server may further comprise a number of programs 960 including programs for processing of SIP signaling according to one or more embodiments of the present invention.

In some embodiments of the present invention, the server 900 is configured to carry out one or more of the methods described above. In particular, server 900 may comprise a processing unit (e.g., CPU 930, configured with appropriate software) configured to receive, via the network communications interface 920, a SIP INVITE message from a SIP User Agent Client for a first communication device, the SIP INVITE message including an early media capability indicator as described above. The processing unit may be further configured to forward the SIP INVITE message, using communications interface 920, to one or more remote communication devices, and to selectively allow one or more media sessions between the first communication device and the one or more remote communication devices, depending on the contents of the early media capability indicator. Those skilled in the art will thus appreciate that server 900 may be configured to carry out any of the methods described herein, as well as variants thereof.

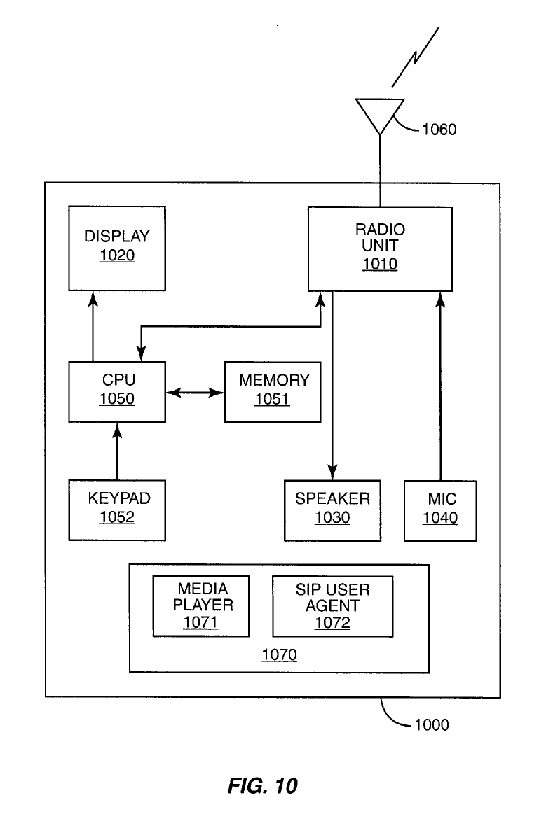

Some of the methods described herein may be implemented at an end-user device. One such end-user device is illustrated in FIG. 10. In the pictured embodiment, communication device 1000 may comprise a mobile telephone, or a personal digital assistance (PDA) device with mobile telephone capabilities. Communication device 1000 includes a central processing unit (CPU) 1050, connected to at least one memory unit 1051, and at least one display 1020. The CPU 1050 may also be connected to a keyboard device or area 1052 to allow subscribers to enter, for example, digits or alphanumeric characters. The memory unit 1051 may include non-volatile memory (e.g., flash, EEPROM or SIM card) in order to retain stored information, should power be temporarily unavailable.

The CPU 1050 is further connected to a radio unit 1010 configured to convert incoming and outgoing data to and from radio frequency (RF) modulated signals. The radio unit 1010 also connects to an antenna 1060 for transmission and reception of the RF signals. Radio unit 1010 may also directly or indirectly be connected to an earphone 1030 and a microphone 1040 in order to allow voice communication. Communication device 1000 may further comprise a plurality of programs 1070, such as a media player 1071, that can render one or more media types (e.g., audio, video) included in a media session, and a SIP User Agent application 1072.

In some embodiments of the present invention, CPU 1050 and/or other processing logic included in communication device 1000 is configured to carry out one or more of the methods described above. In particular, communication device 1000 may comprise a processing unit (e.g., CPU 1050 configured with program code stored in memory 1051) configured to process multi-media service requests. In some embodiments, communication device 1000 may be configured to generate SIP INVITE messages including an early media capability indicator as described above. As may be readily understood by those skilled in the art, the ability of communication device 1000 to receive and process one or more early media streams may depend on the network resources used at a given time. For instance, less bandwidth may be available to communication device 1000 through radio unit 1010 over some wide-area radio networks, at certain times, than might be available at other times through a wireless LAN network. Thus, the content of the early media capability may be adjusted by the communication device 1000 to reflect its current capabilities, depending on the network resources used and/or available to the communication device 1000 at a given time.

In some embodiments, communication device 1000 may be configured to process received SIP INVITE messages according to one or more of the methods described herein. For instance, communication device 1000 may be configured to receive a SIP INVITE message containing an early media capability indicator from a remote communication device, and to selectively initiate one or more early media sessions with the remote communication device based on the early media capability indicator.

Those skilled in the art will appreciate that the various functions of communication device 1000 and server 900 may be performed using various combinations of hardware and software. Accordingly, each of the described processing blocks may in some embodiments directly correspond to one or more commercially available or custom microprocessors, microcontrollers, or digital signal processors. In other embodiments, however, two or more of the processing blocks or functional elements of device 1000 or server 900 may be implemented on a single processor, while functions of other blocks are split between two or more processors. Likewise, memories 1051 and 910 are representative of the one or more memory devices containing the software, firmware, and data used to implement functionality in accordance with one or more embodiments of the present invention. Thus, these memory devices may include, but are not limited to, the following types of devices: cache, ROM, PROM, EPROM, EEPROM, flash, SRAM, and DRAM. It should thus also be understood that at least a portion of the present invention's functionality may be embodied as stored computer instructions in the form of micro-code, firmware, software, etc.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. A method of processing a multi-media service request, the method comprising:
receiving a Session Initiation Protocol (SIP) INVITE message from a SIP User Agent Client for a first communication device, the SIP INVITE message comprising an early media capability indicator;
forwarding the SIP INVITE message to one or more remote communication devices; and
selectively allowing one or more early media sessions between the first communication device and the one or more remote communication devices, based on the early media capability indicator.

2. The method of claim 1, wherein selectively allowing one or more early media sessions between the first communication device and one or more remote communication devices comprises disallowing early media communications to the first communication device if the media capability indicator indicates that no early media is permitted.

3. The method of claim 2, wherein disallowing early media communications to the first communication device if the media capability indicator indicates that no early media is allowed comprises rejecting an early media session offer from a SIP User Agent Server for a remote communication device.

4. The method of claim 1, wherein selectively allowing one or more early media sessions between the first and one or more remote communication devices comprises allowing a single early media session between the first communication device and a single remote communication device if the early media capability indicator indicates that a single early media session is permitted.

5. The method of claim 4, wherein allowing a single early media session comprises accepting an early media session offer from a SIP User Agent Server for a first remote communication device and rejecting an early media session offer from a SIP User Agent Server for a second remote communication device.

6. The method of claim 4, wherein the early media capability indicator indicates that a single early media session is permitted and wherein forwarding the SIP INVITE message to one or more remote communication devices comprises sequentially forwarding the SIP INVITE message to the one or more remote communication devices, the method further comprising modifying the SIP INVITE message after accepting an early media session offer from a SIP User Agent Server for a first remote communication device, so that the SIP INVITE message forwarded to subsequent remote communication devices includes a modified early media capability indicator indicating that no early media sessions are permitted.

7. The method of claim 1, wherein selectively allowing one or more early media sessions between the first communication device and one or more remote communication devices comprises allowing concurrent early media sessions between the first communication device and two or more remote communication devices if the early media capability indicator indicates that parallel early media sessions are permitted.

8. The method of claim 1, wherein selectively allowing one or more early media sessions between the first communication device and one or more remote communication devices comprises allowing sequential early media sessions between the first communication device and two or more remote communication devices if the early media capability indicator indicates that sequential early media sessions are permitted.

9. The method of claim 1, wherein the early media capability indicator is included in a Private Header extension to the SIP INVITE message.

10. The method of claim 1, wherein the early media capability indicator comprises a feature tag included in the SIP INVITE message.

11. The method of claim 1, wherein forwarding the SIP INVITE message to one or more remote communication devices comprises determining a forking method, based on the early media capability indicator.

12. A method of processing a multi-media service request, the method comprising:
receiving a Session Initiation Protocol (SIP) INVITE message from a SIP User Agent Client for a first communication device, the SIP INVITE message comprising an early media capability indicator; and
selectively initiating one or more early media sessions with the first communication device, based on the early media capability indicator.

13. The method of claim 12, wherein selectively initiating one or more early media sessions with the first communication device comprises refraining from initiating an early media session with the first communication device if the media capability indicator indicates that no early media is permitted.

14. The method of claim 12, wherein selectively initiating one or more early media sessions with the first communication device comprises initiating a single early media session with the first communication device if the early media capability indicator indicates that a single early media session is permitted, that sequential early media sessions are permitted, or that parallel early media sessions are permitted.

15. The method of claim 14, wherein initiating a single early media session with the first communication device comprises sending an early media session offer to the first communication device and receiving an early media session acceptance from the first communication device before sending early media to the first communication device.

16. A Session Initiation Protocol (SIP) Proxy Server, comprising a communications interface configured for communication with a first communication device and one or more remote communication devices, and a processing unit configured to:
receive, via the communications interface, a Session Initiation Protocol (SIP) INVITE message from a SIP User Agent Client for the first communication device, the SIP INVITE message comprising an early media capability indicator;
forward the SIP INVITE message, via the communications interface, to one or more remote communication devices; and
selectively allow one or more early media sessions between the first communication device and the one or more remote communication devices, based on the early media capability indicator.

17. The SIP Proxy Server of claim 16, wherein the processing unit is configured to selectively allow one or more early media sessions between the first and one or more remote communication devices by rejecting an early media session offer from a SIP User Agent Server for a remote communication device if the media capability indicator indicates that no early media is permitted.

18. The SIP Proxy Server of claim 16, wherein the processing unit is configured to selectively allow one or more early media sessions between the first and one or more remote communication devices by allowing a single early media session between the first communication device and a single remote communication device if the early media capability indicator indicates that a single early media session is permitted.

19. The SIP Proxy Server of claim 18, wherein the processing unit is configured to allow a single early media session by accepting an early media session offer from a SIP User Agent Server for a first remote communication device and rejecting an early media session offer from a SIP User Agent Server for a second remote communication device.

20. The SIP Proxy Server of claim 18, wherein the early media capability indicator indicates that a single early media session is permitted, wherein the processing unit is configured to forward the SIP INVITE message to one or more remote communication devices by sequentially forwarding the SIP INVITE message to the one or more remote communication devices, and wherein the processing unit is further configured to modify the SIP INVITE message after accepting an early media session offer from the SIP User Agent Server for a first remote communication device, so that the SIP INVITE message forwarded to subsequent remote communication devices includes a modified early media capability indicator indicating that no early media sessions are permitted.

21. The SIP Proxy Server of claim 16, wherein the processing unit is configured to selectively allow one or more early media sessions between the first communication device and one or more remote communication devices by allowing concurrent early media sessions between the first communication device and two or more remote communication devices if the early media capability indicator indicates that parallel early media sessions are permitted.

22. The SIP Proxy Server of claim 16, wherein the processing unit is configured to selectively allow one or more early media sessions between the first communication device and one or more remote communication devices by allowing sequential early media sessions between the first communication device and two or more remote communication devices if the early media capability indicator indicates that sequential early media sessions are permitted.

23. The SIP Proxy Server of claim 16, wherein the processing unit is configured to determine a forking method, based on the early media capability indicator, before forwarding the SIP INVITE message to one or more remote communication devices.

24. A Session Initiation Protocol (SIP) device comprising a communications interface configured for communication with a first communication device or a proxy for the first communication device, or both, and a processing unit configured to:
receive a Session Initiation Protocol (SIP) INVITE message from a SIP User Agent Client for the first communication device, the SIP INVITE message comprising an early media capability indicator; and
selectively initiate one or more early media sessions with the first communication device, based on the early media capability indicator.

25. The SIP device of claim 24, wherein the processing unit is configured to selectively initiate one or more early media sessions with the first communication device by initiating a single early media session with the first communication device if the early media capability indicator indicates that a single early media session is permitted, that sequential early media sessions are permitted, or that parallel early media sessions are permitted.

26. The SIP device of claim 24, wherein the SIP device comprises an end-user device.
